(19) United States
(12) Patent Application Publication
(10) Pub. No.: US 2003/0136192 A1
(43) Pub. Date: Jul. 24, 2003

(54) System and method for detecting noises and sounds in wheels, tires and bearings of a vehicle

(76) Inventors: Jia-Heng Tu, North York (CA); Yi-Chi Shih, Palos Verdes, CA (US); Winnie Shih, Brossard (CA)

Correspondence Address: Jia-Heng Tu, 43 Hillmount Avenue, North York, ON, M6B 1X3, CA

(21) Appl. No.: 10/053,091

(22) Filed: Jan. 23, 2002

(51) Int. Cl. G01N 29/00

(52) U.S. Cl. 73/587

(57) ABSTRACT

There is disclosed a system for detecting defects in wheels, tires, bearing and supporting mechanisms of a vehicle. A plurality of microphones is installed in different locations of the vehicle to receive noises or sounds when the vehicle is in motion. The electrical signals converted from the noises or sounds by each microphone are fed to an amplifier and filter circuit. The amplified signals are fed to a loudspeaker located preferably in the compartment of the driver. By sequentially monitoring the levels of the amplified and filtered signals from each microphone or in a pair of microphones, defects in the wheels, tires and bearings can be detected before the occurrence of further damages or accidents. The levels of the amplified signals from each microphone may be displayed simultaneously by an array of light emitting devices. In addition, a plurality of video cameras is installed in order to detect and transmit video images of said wheels, tires, bearing and supporting mechanisms of the vehicle to assist the detection of said defects.

### BACKGROUND OF THE INVENTION

1. Field of the Invention

This invention relates to a system for detecting defects in wheels, tires and bearings of a vehicle in motion.

2. Prior Art

After the operation of a vehicle for a certain period of time, it is quite possible that some defects may develop either in the wheels, tires or the bearings. Defects in the wheels include the deformation of wheel rims arising from accidental impacts or over-loading. Defects in tires may be due to excessive friction, impacts, punctuation and insufficient air pressure. It is also possible to develop defects in wheel bearings which support the weight and forces of the entire vehicle. In addition to the above items, defects in the wheel supporting or steering mechanisms may also develop. When one or more of these defects start to develop, abnormal noises or sounds may appear when the vehicle is in motion. However, it is often difficult for the driver to notice or detect these noises or sounds in the initial stage of the defects, due to the acoustic isolation of driver compartment and due to velocity of the vehicle. This is especially true for large size vehicles such as heavy duty trucks and trains, where the distances between wheels and the driver compartment are relatively large.

If these defects are not detected in the early stage and corrected, further damages or breakdown of the wheels, tires or the supporting mechanisms may occur. This will not only cause accidents to the vehicle and the driver but also pose certain safety threats and damages to other vehicles or passengers traveling near it on the same highway. To detect these defects, a driver may require another vehicle to drive along on a highway to sense unusual noises or sounds emitted from his vehicle. The presence or lack of presence of the unusual noises or sounds is then signaled to the driver. However, this method is not convenient as it is difficult to identify and to request another driver who is willing to detect the unusual noises or sounds. Even such another driver has agreed, the noise detection may not be reliable to achieve as another driver is situated in the other acoustically isolated compartment. The noises or sounds associated with the defects in wheels, tires, bearings may also be checked by an inspector in an inspection center. However, in this case the presence of the unusual noises or sounds may not be readily detected due to the reduced vehicle speed imposed when a vehicle is traveling through an inspection center. From the above comments, it is evident that there is a need to develop a system and method to detect the unusual noises or sounds from a vehicle in motion, preferable by the driver himself, before severe damages or accidents are developed.

### SUMMARY OF THE INVENTION

It is therefore an object of this invention to provide a system for detecting unusual noises or sounds emitted from a moving vehicle arising from defects in wheels, tires, bearing or the supporting mechanisms, thereby preventing damages to the vehicle and the occurrence of accidents. It is another object of this invention to provide an audio display method to display noises or sounds emitted from wheels, tires, bearings of a vehicle in order to assist a driver to detect defects associated with them. It is yet another object of this invention to provide a video display method to display noises or sounds emitted from wheels, tires, bearings of a vehicle in order to assist a driver detect defects associated with them.

According to the present invention, there is provided a system for detecting unusual noises or sounds emitted by a moving vehicle due to defects in wheels, tires, bearings and supporting mechanisms. A plurality of microphones are installed in the vehicle, each near a group of wheels and tires to be detected. The acoustic signals from each microphone are converted into electrical signals and fed to an amplifier circuit. Alternately, the acoustic signals from these microphones may be converted into electrical signals and fed sequentially to a same amplifier circuit. The amplified signals are fed to at least one loudspeakers or an earphone located preferably in the compartment of the driver of the vehicle. Since the chance of developing the same defects in all wheels and tires is extremely small, it is highly likely that when defects develop, they will start from a specific group of wheels, tires or bearings. Hence, the noises or sounds emitted from different groups of wheels, tires or bearings will be different when the vehicle is set in motion. By sequentially monitoring the levels of the amplified signals from each group or a pair of groups, defects in the wheels and tires can be detected by the driver before the occurrence of fatal accidents or further damages. According to another embodiment of this invention, the amplified signals may be filtered using a filter circuit. The filter is added so that noises or sound associated with certain defects may be allowed to displayed.

In addition to the transmission of the unusual noises or sounds from the vicinity of wheels, tires and bearings and display of the signals in an audio form, the levels of noises or sounds received by each microphone may be displayed in a visual form. According to yet another embodiment of this invention, the noise or sound level from each microphone is displayed in the driver compartment by a light generating device such as light emitting diode. The intensity of the light generating device is proportional to the level of the noises or sounds detected. Alternately, the intensity of the light generating device may be inversely proportional to the level of noises or sounds detected. According to still another embodiment of this invention, the unusual noises or sounds received by the microphones may be recorded by a recording device. The signals then can be analyzed or verified by experienced inspectors in a service center.

In addition to the detection and display of acoustic signals, according to still another embodiment of this invention, a plurality of video cameras may be installed in locations in order to detect and transmit video images of said wheels, tires, bearing and supporting mechanisms of the vehicle to assist the detection of said defects.

### BRIEF DESCRIPTION OF THE DRAWINGS

FIG. 1 is a schematic diagram showing a top view of a vehicle with six groups of wheels/tires/bearings [2, 3, 4, 5, 6, 7]. The approximate locations of the microphones [12, 13, 14, 15, 16, 17] installed in the vehicle for the detection of the unusual noises or sounds due to defects in wheels, tires or bearings are shown.

FIG. 2 is a schematic diagram showing a more detailed view of the arrangement for the microphones [12, 13, 14, 15, 16, 17] and receiver and display unit [18] to receive and display noises or sounds in an audio and video forms.

FIG. 3 is a schematic diagram showing a selection circuit for a portion of the receiver and display unit. The selection of the microphone to display the signals may be activated manually or electronically.

FIG. 4 shows (a) a view for a group of wheel [4] with a microphone [14] installed below the floor bed [8] of the vehicle and (b) a view for a group of wheel with a microphone installed above the floor bed of the vehicle.

FIG. 5 is a schematic diagram showing the arrangement of the microphones and receiver and display unit to receive and display noises or sounds in a audio and video forms. One amplifier [12A, 13A, 14A, 15A, 16A, 17A] is connected and adjacent to a microphone to amplify the electrical signals in order to reduce effects of unwanted electrical noises.

### DESCRIPTION OF THE PREFERRED EMBODIMENTS

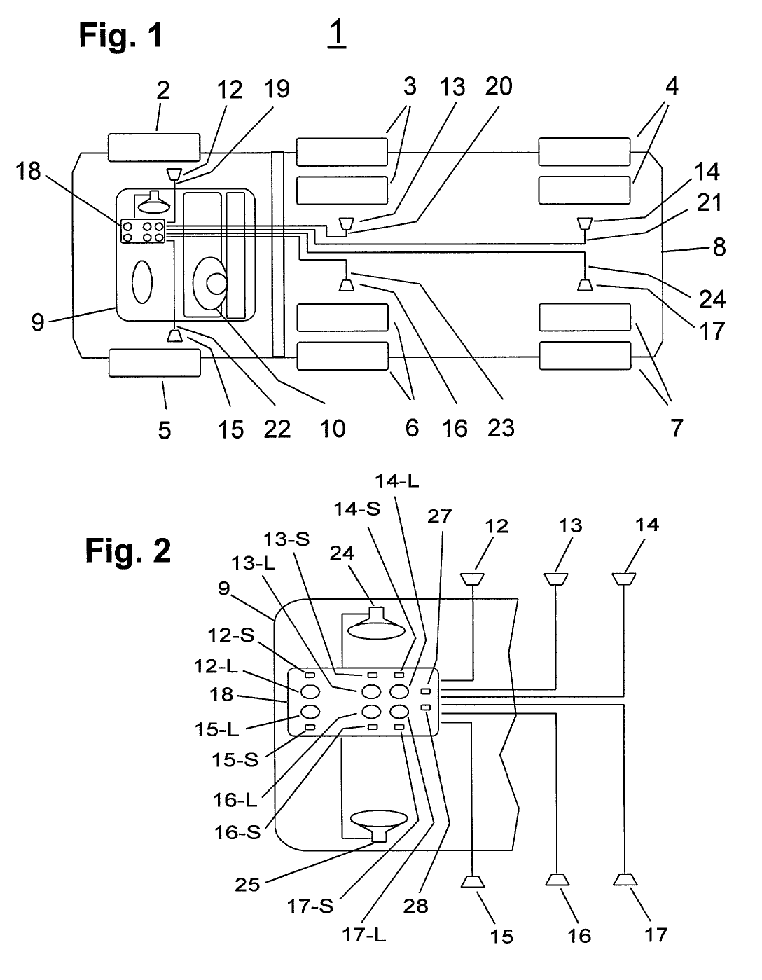

The principles of the present invention will be first described with reference to FIG. 1, which shows a schematic top view of a vehicle [1]. To simplify the description, only the groups of wheels/tires/bearings [2,3,4,5,6,7] (each of which is represented by a rectangle), floor bed [8] of the vehicle and driver's compartment [9] are shown. It should be mentioned that the vehicle displayed in FIG. 1 is chosen for description purposes. The principles of this invention should equally apply to vehicles with numbers of wheels, wheel arrangements and dimensions different from the one shown in FIG. 1. Furthermore, this invention is effective in detecting defects in wheels, bearings for vehicles traveling along fixed tracks, such as conventional trains with or without tires. It is noted in FIG. 1 that each of the two front groups [2,5] consists of one wheel/tire/bearing, whereas each of the remaining groups [3,4,6,7] consists of two wheels/tires/bearings.

When defects develop in these wheels, tires, bearings and other supporting parts of the vehicle, various noises or sounds may be generated when the vehicle is in motion. The frequency of noises or sounds detectable by a normal person may be in a range from 20 Hz to 20 kHz. However, since the detection in this invention is achieved by microphones and electronic circuits, noises or sounds at frequencies other than the values in the above range may well be detected. It is also noted that under normal operation conditions of a vehicle, the noises or sounds may not be simple sinusoidal functions but consist of mixed signals of various frequencies. Since the chance of developing the same defects in all groups of wheels, tires and bearings simultaneously is extremely small, it is highly likely that when such defects develop, they will start from a specific group of wheel(s), tire(s) or bearing(s). Hence, the noises or sounds from the wheel(s), tire(s) or bearing(s) in a group where the defects are present will be different from the noises or sounds emitted from other groups of the wheel(s), tire(s) or bearing(s) when the vehicle is set in motion. If the noises or sounds emitted from the groups of wheel(s), tire(s) or bearing(s) can be monitored by the driver [10] situated in the driver's compartment [9], then the status of whether defects in wheel(s), tire(s) or bearing(s) in the vehicle are present or not may be obtained by the driver. According to one embodiment of this invention, methods are provided to transmit noises and sounds emitted from groups of wheels, tires and bearings to the driver. The information on the levels or differences of noises or sounds emitted from different groups of wheel(s), tire(s) or bearing(s) can thus assist the driver to identify defects and to perform preventive examination and maintenance to minimize further damages or accidents.

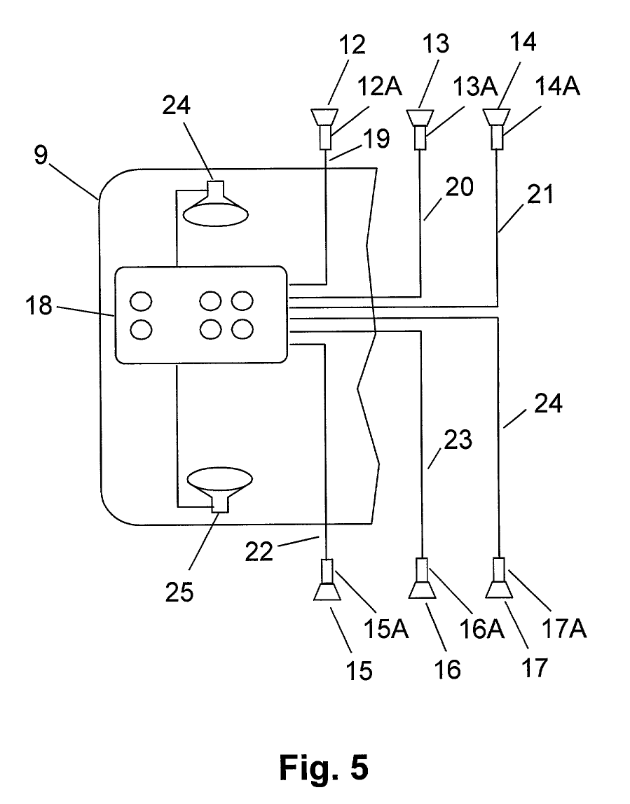

According to another embodiment of this invention, as shown in FIG. 1, this defect detection is achieved by installing at least one microphone [12,13,14,15,16,17] in each region where a wheel or a group of wheels [2,3,4,5,6,7] is located. The microphones receive noises or sounds generated from the wheels, tires, bearings and convert them into electrical signals. The electrical signals from these microphones are connected to a receiver and display unit [18], which is preferably located in the driver compartment, through cables [19,20,21,22,23,24]. DC voltage and current required to operate a microphone are supplied from the receiver and display unit through these cables. The electrical signals are amplified and filtered if necessary by amplifying [31, FIG. 5]] and filtering [30, FIG. 5] circuits residing within the receiver and display unit [18]. The amplified signals are finally displayed in a visual or audio form to the driver. In order to avoid saturation of the amplifier in the receiver and display unit, it is preferable to allow an adjustable gain for the amplifier. In addition to the connection through cables between the microphones and the receiver and display unit, the connection may also be achieved by wireless radio. In this case, a transmitting radio is attached to each microphone and a carrier signal, preferably at a frequency higher than the frequencies of noises and sounds, is modulated by the received signals and sent to the receiver by radio waves.

Visual display of the sounds or noises from each group of wheel(s), tire(s) or bearing(s) is achieved by an array of light emitting devices, such as light emitting diodes. FIG. 2 shows a more detailed view of the receiver and display unit [18]. Here, light emitting devices are indicated by [12-L, 13-L, 14-L, 15-L, 16-L and 17-L]. Each light emitting device displays the levels of sounds or noises from the corresponding microphone. It is preferable to arrange the light emitting devices in the receiver and display unit so that the intensity of light from each light emitting device is proportionally to the level of sounds or noises from the corresponding microphone. For instance, a higher brightness in a light emitting device represents stronger noises or sounds received by the corresponding microphone. Conversely, a lower brightness in a light emitting device may be adopted to represent stronger noises or sounds received by the corresponding microphone. It is also preferable to arrange the locations of the light emitting devices in the receiver and display unit in such a way that a light emitting device at a given location corresponds to a specific group of the wheel(s), tire(s) or bearing(s) being displayed. For example, in FIG. 2, the light emitting device [12-L] displays signals received by microphone [12], the light emitting device [13-L] displays signals received by microphone [13], the light emitting device [14-L] displays signals received by microphone [14], the light emitting device [15-L] displays signals received by microphone [15], the light emitting device [16-L] displays signals received by microphone [16], and the light emitting device [17-L] displays signals received by microphone [17]. Hence, when one or more of the light emitting devices display light stronger or weaker than the other light emitting devices, the driver can immediately identify the groups of wheels, tires and bearings where possible defects may have occurred.

Audio display of the sounds or noises from each group of wheel(s), tire(s) or bearing(s) may be achieved by one or two loud speakers [24, 25] as shown in FIG. 2. Each loud speaker displays the levels of sounds or noises from a given microphone which is connected to said loud speaker. The selection of the microphone from which the signals to be displayed by a loud speaker will be carried out by the driver, by pressing the selecting switches [12-S, 13-S, 14-S, 15-S, 16-S and 17-S] in the receiver and display unit. Audio signals from microphones [12, 13, 14] which are located in the right-hand side of the vehicle are displayed separately by a first loud speaker [24] situated in the right-hand side of the driver, whereas audio signals from microphones [15, 16, 17] which are located in the left-hand side of the vehicle are displayed separately by a second loud speaker [25] situated in the left-hand side of the driver. Hence, when the switch [12-S] is pressed, signals from the microphone [12] will be connected to the first loud speaker [24]. Signals from the other two microphones [13, 14] located also in the right-hand side will be disconnected from the first loud speaker. Similarly, when the switch [16-S] is pressed, signals from the microphone [16] will be connected to the second loud speaker [25]. Signals from the other two microphones [15, 17] located in the left-hand side will be disconnected from the second loud speaker [25]. It is thus clear that only the signals from one microphone are displayed by one loud speaker at a time. It is also preferable to arrange the receiver and display unit so that the level of sounds generated from each loud speaker is proportionally to the level of sounds or noises received from the corresponding microphone. Alternately, it may be arranged so that the level of audio signals generated from each loud speaker is inversely proportional to the level of noises or sounds detected. This is done so that any possible defects in the wheels, tires and bearings being monitored can be detected easily. In the above applications to display levels of noises or sounds by the two loud speakers, it is preferable to maintain the gain, of amplification factor of the right-hand amplifier connected to the said first loud speaker to the same as the gain for the left-hand amplifier connected to the second loud speaker.

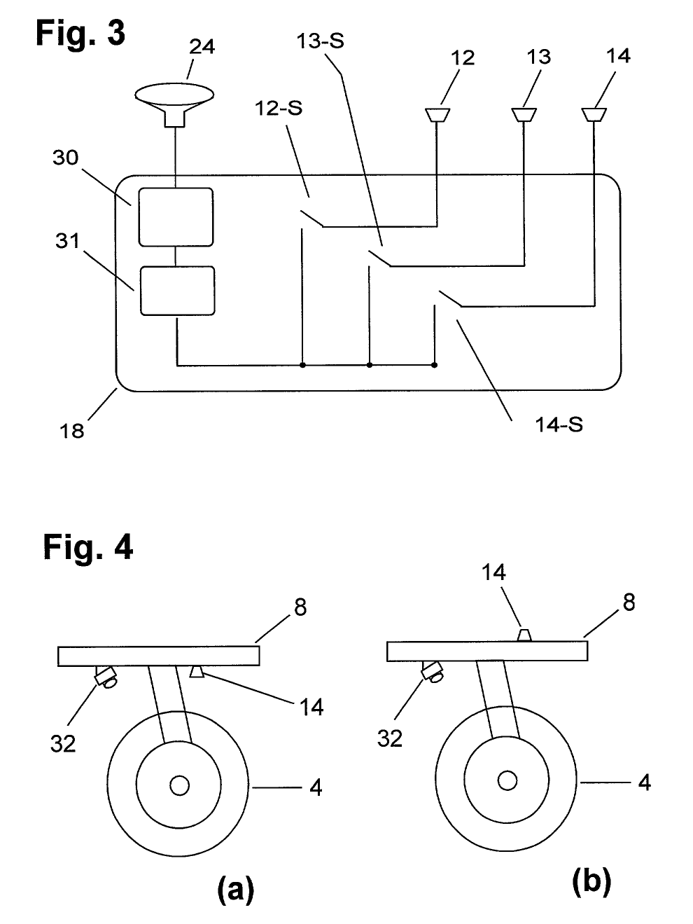

When the audio display is adopted, it may also be beneficial to display signals from two groups of wheels, tires and bearings simultaneously at a given time to facilitate the detection of the defects. In this case, for instance, noises or sounds from microphone [12], which is located in the right-hand side, will be displayed by the first loud speaker [24], whereas noises and sounds from microphone [15] which is located in the left-hand side will be displayed by the second loud speaker [25]. After the display of signals from these two wheel groups, signals from two other groups: [13,16] and [14,17] may then be displayed sequentially, in order to allow the driver to compare the differences in the noises and sounds emitted from different groups of wheels, tires and bearings and to detect the presence of defects. If this display mode is adopted, only one selecting switch is sufficient for each pair of the microphones. For instance, either switch [12-S] or [15-S] is required for the selection of the pair of microphones [12, 15] for displaying. The above detection and display of noises and sounds may be activated and selected manually by the driver by pressing power switch [22], which turns on or turns off electrical power to the receiver and display unit. A part of the circuit for the section and activation of the receiver and display unit for the detection of noises and sounds is given in FIG. 3. To simplify the description, the power switch [27] and mode switch [28] are not shown. Here, it is noted that only one of the three switches [12-S, 13-S, 14-S] can be close at a time. Hence, for instance, when the switch [12-S] is pressed or activated the signals of noises or sounds from microphone [12] will be connected to the amplifier [31] and filter [30] circuits. The amplified signals are then fed to the first loud speaker [24]. Whereas the other two switches [13, 14] will not be close so that signals from microphones [13, 14] will be prevented from reaching the amplifier circuit.

Alternately, the control of display of the audio signals may be accomplished by an electronic processor. This detection mode may be triggered by the driver by pressing the mode switch [28] shown in FIG. 2. When the circuit is triggered, signals of the noises and sounds received from the first two groups of wheels, tires and bearings will be displayed. After a predetermined period of time (about 5-10 seconds), the signals from the first two groups will be disconnected and signals from the second two groups will be displayed. This will be continued until signals from all groups have been displayed.

It is thus clear that the above system and method will assist the driver to determine if the wheels, tires, bearings and supporting mechanisms in his vehicle are in normal operating conditions or if it is required to take preventive examination and maintenance in order minimize further damages to the vehicle and possible accidents as a results of the defects.

As stated before, each microphone should be installed preferably with the noise and sound detection element facing the location where the wheels, tires and bearings to be detected is situated. As shown in FIG. 4(a), a microphone (14) may be installed on the bottom surface of the vehicle floor (8) or in FIG. 4(b) on the upper surface of the vehicle floor, provided the thickness of the floor material in the vicinity of the microphone is not too large so that sufficient acoustic signals generated from the wheels, tires and bearings can reach the microphone for the noise and sound detection. When the microphone is installed below the floor bed of the vehicle, it may be necessary to cover the microphone with a thin material, such as a plastic sheet, to protect it from dust and water. The material and thickness of the thin plastic sheet are selected so that noises or sounds to be monitored can penetrate through to reach the microphone.

Since the frequencies of noises and sounds generated from the wheels, tires and bearings due to different defects may be different, a filter device [30] shown in FIG. 3 may be used to select a range of acoustic frequencies corresponding to one type of defect before displaying the signals to the driver. The filter is a conventional audio band pass filter where the central pass band frequency is adjustable to allow the driver to select acoustic frequency band for the detection. One other advantage of using the electronic filter is that a portion of sounds or noises associated with a normal engine operation may be minimized.

It is also noted that unwanted electrical noises may be induced in the signal carrying cables [19, 20, 21, 22, 23, 24] connecting the microphones and the amplifier and filter circuits, as shown in FIG. 1, due to electromagnetic induction and the length of these cables. The induced electrical noises may affect the detection of the noises and sounds signals due to low signals levels generated by a conventional microphone. In this case, it is preferable to employ shielded connecting cables for the connection. Alternately, as shown in FIG. 5, amplifiers [12A, 13A, 14A, 15A, 16A, 17A] may be installed near the corresponding microphones [12, 13, 14, 15, 16, 17] to amplify the signals before transmission to the receiver and display unit. The band width of the amplifiers is preferable to cover the range from 10 Hz to 20 kHz. This will minimize the unwanted induction of electrical noises in the entire system. After the amplification, the amplified signals are fed to the receiver and display unit [18] located in the compartment of the driver, which contains another amplifier with adjustable gain and the filter circuit.

According to another embodiment of this invention, to facilitate the analysis of the detected signals arising from noises and sounds from the groups of wheels, tires and bearings, the signals received may be stored sequentially in an electronic memory. In this case, it is preferable to store broad band signals from the microphones in the electronic memory in order to preserve complete audio signals received. Furthermore, an additional signal for group identification may be added to the memory before recording the signals which are corresponding to a specific group of wheels, tires and bearings. Finally, the signals may be stored in a parallel manner using multiple channel memory device, instead of in a sequential manner. The signals stored in the electronic memory can then be inspected by experienced inspectors in a service center, to determine the causes and sources of the defects.

To detect the possible defects in the wheels, tires, bearings and mechanisms, according to yet another embodiment of this invention, in addition to the microphones, miniature video cameras may be installed (32, see FIG. 4). Video signals from each camera can be displayed in a video form in a monitor located in the compartment. This video display is particularly useful when defects in one of the groups of wheels, tires, bearings cause an overheating and emission of smoke from the bearings. The video signals may be transmitted to the receiver and display unit either through cables or wireless radios. Finally, according to still another embodiment of this invention, a heat sensing element may be installed with each of the microphone to sense the heat emitted by each group of wheels, tires, bearings. When defects are present in the bearings, excessive heat is often generated due to excess friction. By sensing the temperature of the wheels, tires, bearings in a group and comparing it with that from other group, the defects may be detected. In this case, it is evident there is a need to add a sensing and comparing circuit to process the signal receive from the heat sensors. The heat sensors could be selected from a group comprising: cooled or uncooled semiconductor infrared sensors, cooled or uncooled pyroelectric infrared sensors and bolometric infrared heat sensors.

What is claimed is:

1. A system for detecting defect(s) in wheels, tires, bearings and supporting mechanisms of a vehicle in motion, comprising:
a. a plurality of microphones each mounted in a region in the vicinity of a wheel or a group of wheels for detecting noises and sounds generated by said wheels, tires, bearings and supporting mechanisms and creating electrical signals responding to said noises and sounds;
b. a transmission means to transmit said electrical signals;
c. a receiver means and an amplification means for each of the said microphones to amplify said electrical signals from said microphones due to the noises and sounds generated;
d. a display means to display levels of said electrical signals after amplification from said microphones.

2. A system for detecting defects in wheels, tires, bearings and supporting mechanisms of a vehicle in motion in claim 1, wherein said microphones are located beneath floor bed of said vehicle.

3. A system for detecting defects in wheels, tires, bearings and supporting mechanisms of a vehicle in motion in claim 1, wherein said microphones are located above floor bed of said vehicle.

4. A system for detecting defects in wheels, tires, bearings and supporting mechanisms of a vehicle in motion in claim 1, wherein gain of amplification of said amplification means is adjusted so as to avoid saturation of said amplification means.

5. A system for detecting defects in wheels, tires, bearings and supporting mechanisms of a vehicle in motion in claim 1, further comprising a variable filter means to select central frequency of amplified acoustic signals.

6. A system for detecting defects in wheels, tires, bearings and supporting mechanisms of a vehicle in motion in claim 1, wherein said display means is in an audio form.

7. A system for detecting defects in wheels, tires, bearings and supporting mechanisms of a vehicle in motion in claim 1, wherein said display means is in an video form.

8. A system for detecting defects in wheels, tires, bearings and supporting mechanisms of a vehicle in motion in claim 1, wherein display of said levels of signals is in a sequential form.

9. A system for detecting defects in wheels, tires, bearings and supporting mechanisms of a vehicle in motion in claim 1, wherein display of said levels of signals is in a simultaneous form.

10. A system for detecting defects in wheels, tires, bearings and supporting mechanisms of a vehicle in motion in claim 1, further comprising a step of storing said signals after amplification is a memory device.

11. A system for detecting defects in wheels, tires, bearings and supporting mechanisms of a vehicle in motion in claim 1, wherein said transmission means is a conducting cable.

12. A system for detecting defects in wheels, tires, bearings and supporting mechanisms of a vehicle in motion in claim 1, wherein said transmission means is a wireless radio.

13. A system for detecting defects in wheels, tires, bearings and supporting mechanisms of a vehicle in motion in claim 1, further comprising a step of installing an infrared sensor device with each of said microphones, said infrared sensor detects infrared beams due to heat generated in said wheels, tires, bearings to indicate said defects.

14. A system for detecting defect(s) in wheels, tires, bearings and supporting mechanisms of a vehicle in motion, comprising:
a. a plurality of microphones each mounted in a region in the vicinity of a wheel or a group of wheels for detecting noises and sounds generated by said wheels, tires, bearings and supporting mechanisms and creating electrical signals responding to said noises;
b. a plurality of video cameras each mounted in a region in the vicinity of a wheel or a group of wheels for detecting images of said wheels, tires, bearings and supporting mechanisms;
c. a transmission means to transmit said electrical signals responding to said noises, and said images;
d. an amplification means for each of the said microphones to amplify electrical signals from said microphones due to the acoustical noises;
e. a display means to display levels of said electrical signals after amplification from said microphones;
f. an image processing means to process and display said images from said video cameras.

15. A system for detecting defects in wheels, tires, bearings and supporting mechanisms of a vehicle in motion in claim 14, wherein said microphones are located beneath floor bed of said vehicle.

16. A system for detecting defects in wheels, tires, bearings and supporting mechanisms of a vehicle in motion in claim 14, wherein said microphones are located above floor bed of said vehicle.

17. A system for detecting defects in wheels, tires, bearings and supporting mechanisms of a vehicle in motion in claim 14, wherein gain of amplification of said amplification means is adjusted so as to avoid saturation of said amplification means.

18. A system for detecting defects in wheels, tires, bearings and supporting mechanisms of a vehicle in motion in claim 14, further comprising a variable filter means to select central frequency of amplified acoustic signals.

19. A system for detecting defects in wheels, tires, bearings and supporting mechanisms of a vehicle in motion in claim 14, wherein said display means is in an audio form.

20. A system for detecting defects in wheels, tires, bearings and supporting mechanisms of a vehicle in motion in claim 14, wherein said display means is in an video form.

21. A system for detecting defects in wheels, tires, bearings and supporting mechanisms of a vehicle in motion in claim 14, wherein display of said levels of signals is in a sequential form.

22. A system for detecting defects in wheels, tires, bearings and supporting mechanisms of a vehicle in motion in claim 14, wherein display of said levels of signals is in a simultaneous form.

23. A system for detecting defects in wheels, tires, bearings and supporting mechanisms of a vehicle in motion in claim 14, further comprising a step of storing said signals after amplification is a memory device.

24. A system for detecting defects in wheels, tires, bearings and supporting mechanisms of a vehicle in motion in claim 14, wherein display of said images from said cameras is sequential.

25. A system for detecting defects in wheels, tires, bearings and supporting mechanisms of a vehicle in motion in claim 14, wherein display of said images from said cameras is simultaneous.

26. A system for detecting defects in wheels, tires, bearings and supporting mechanisms of a vehicle in motion in claim 14, wherein said transmission means for said electrical signals and images is a conducting cable.

27. A system for detecting defects in wheels, tires, bearings and supporting mechanisms of a vehicle in motion in claim 14, wherein said transmission means for said electrical signals and images is a wireless radio.

28. A system for detecting defects in wheels, tires, bearings and supporting mechanisms of a vehicle in motion in claim 14, further comprising a step of installing an infrared sensor device with each of said microphones, said infrared sensor detects infrared beams due to heat generated in said wheels, tires, bearings to indicate said defects.
